(19) United States
(12) Patent Application Publication
(10) Pub. No.: US 2016/0025543 A1
(43) Pub. Date: Jan. 28, 2016

(54) Measuring Spoon With Spill Reduction Feature

(71) Applicant: Focus Products Group International, LLC, Lincolnshire, IL (US)

(72) Inventors: Matthew L. Krumm, Chicago, IL (US); Christopher M. Dorion, Elmhurst, IL (US); Eunice H. Jang, Buffalo Grove, IL (US); William A. Bucklew, Wilmette, IL (US); Zhe Shen, Palatine, IL (US)

(21) Appl. No.: 14/341,268

(22) Filed: Jul. 25, 2014

(51) Int. Cl. G01F 19/00

(52) U.S. Cl. CPC G01F 19/002

(57) ABSTRACT

A measuring spoon has a cup member extending from a handle. The cup member is configured for measurement of liquids. The cup member has a smooth interior surface bounded by an outer rim and a protrusion below the outer rim parallel to the outer rim. The outer rim defines an opening of the cup member. The protrusion is arranged in the interior surface of the cup at a position corresponding to a specified liquid volume measurement of the measuring spoon cup member.

### BACKGROUND AND SUMMARY

This disclosure relates to a measuring spoon that may be used primarily in the kitchen for cooking. In one aspect, the disclosure relates to a double-ended measuring spoon. In another aspect, the disclosure relates to a double-ended measuring spoon with one end used for dry measurements and the opposite end used for liquid measurements. In another aspect, the disclosure relates to a measuring spoon with a liquid measurement end that has a spill reduction feature.

### BRIEF DESCRIPTION OF THE DRAWINGS

FIG. 1 shows a perspective view of a first embodiment of a double-ended measuring spoon.

FIG. 2 shows an alternate perspective view of the measuring spoon of FIG. 1.

FIG. 3 is a top view of the measuring spoon of FIG. 1.

FIG. 4 is a bottom view of the measuring spoon of FIG. 3.

FIG. 5 is a front view of the measuring spoon of FIG. 3.

FIG. 6 is a back view of the measuring spoon of FIG. 3.

FIG. 7 is a left side view of the measuring spoon of FIG. 3.

FIG. 8 is a right view of the measuring spoon of FIG. 3.

FIG. 9 is an enlarged view of FIG. 7;

FIG. 10 is an enlarged view of FIG. 8;

FIG. 11 shows a perspective view of a second embodiment of a double-ended measuring spoon.

FIG. 12 shows an alternate perspective view of the measuring spoon of FIG. 11.

FIG. 13 is a top view of the measuring spoon of FIG. 11.

FIG. 14 is a bottom view of the measuring spoon of FIG. 13.

FIG. 15 is a front view of the measuring spoon of FIG. 13.

FIG. 16 is a back view of the measuring spoon of FIG. 13.

FIG. 17 is a left side view of the measuring spoon of FIG. 13.

FIG. 18 is a right view of the measuring spoon of FIG. 13.

FIG. 19 is an enlarged view of FIG. 17;

FIG. 20 is an enlarged view of FIG. 18;

FIG. 21 shows a perspective view of a third embodiment of a double-ended measuring spoon.

FIG. 22 shows an alternate perspective view of the measuring spoon of FIG. 21.

FIG. 23 is a top view of the measuring spoon of FIG. 21.

FIG. 24 is a bottom view of the measuring spoon of FIG. 23.

FIG. 25 is a front view of the measuring spoon of FIG. 23.

FIG. 26 is a back view of the measuring spoon of FIG. 23.

FIG. 27 is a left side view of the measuring spoon of FIG. 23.

FIG. 28 is a right view of the measuring spoon of FIG. 23.

FIG. 29 is an enlarged view of FIG. 27;

FIG. 30 is an enlarged view of FIG. 28; and

FIGS. 31 and 32 illustrate a spill reduction feature associated with a liquid measuring end of the measuring spoons of FIGS. 1-30.

### DETAILED DESCRIPTION

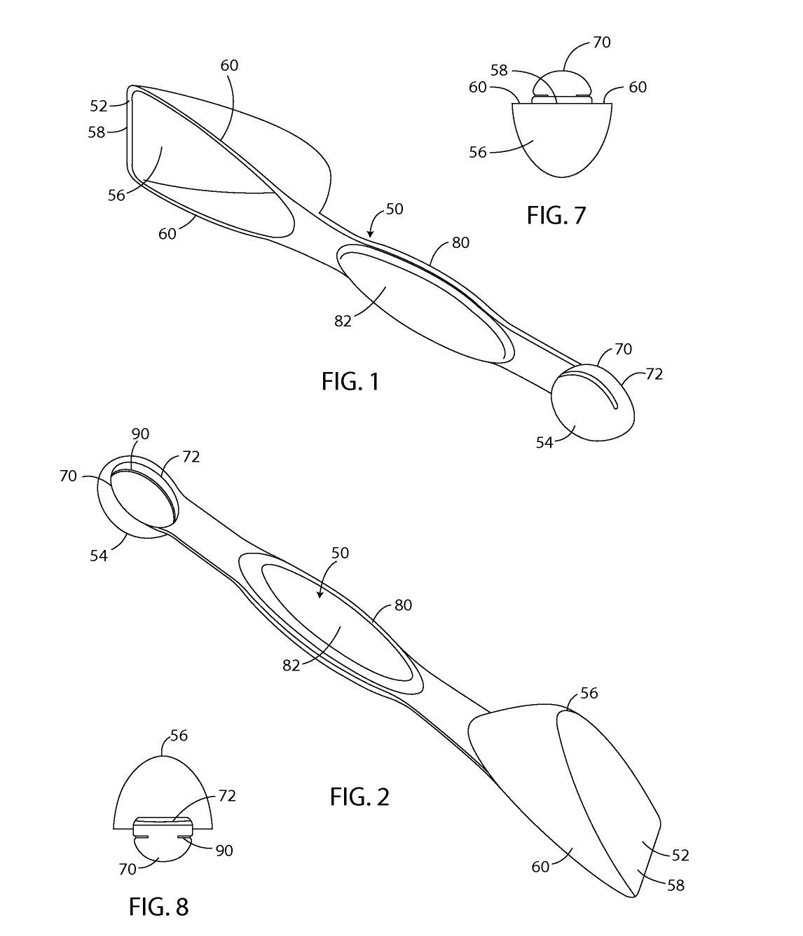

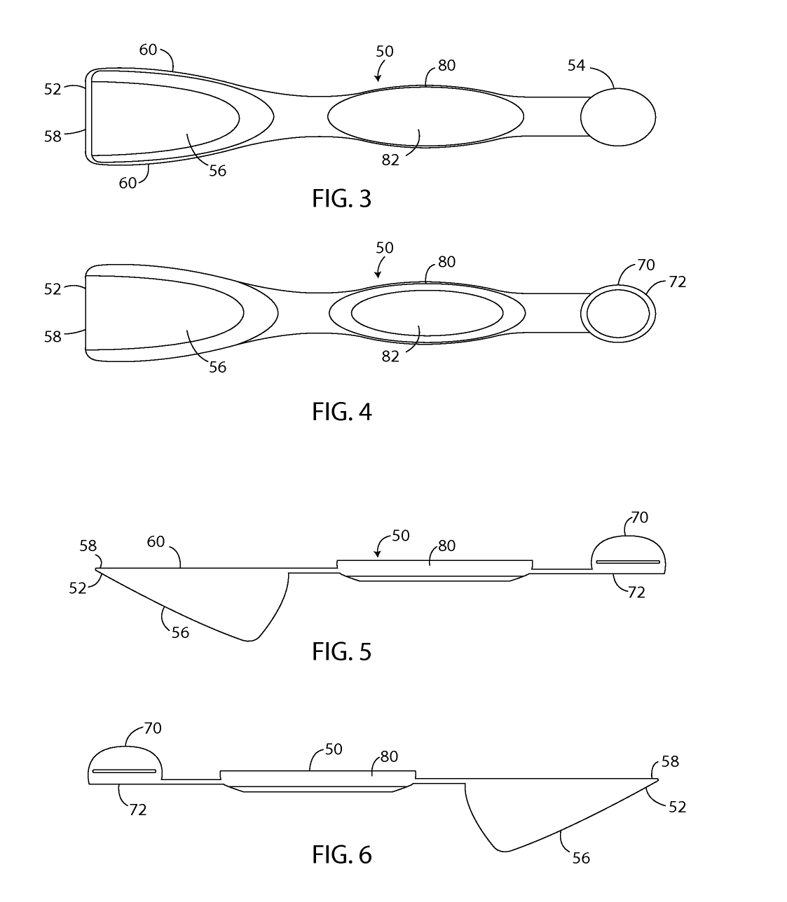

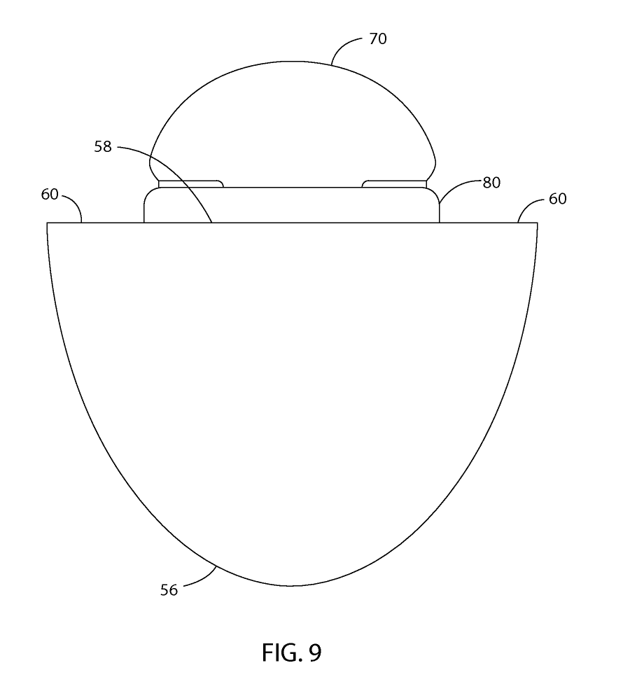

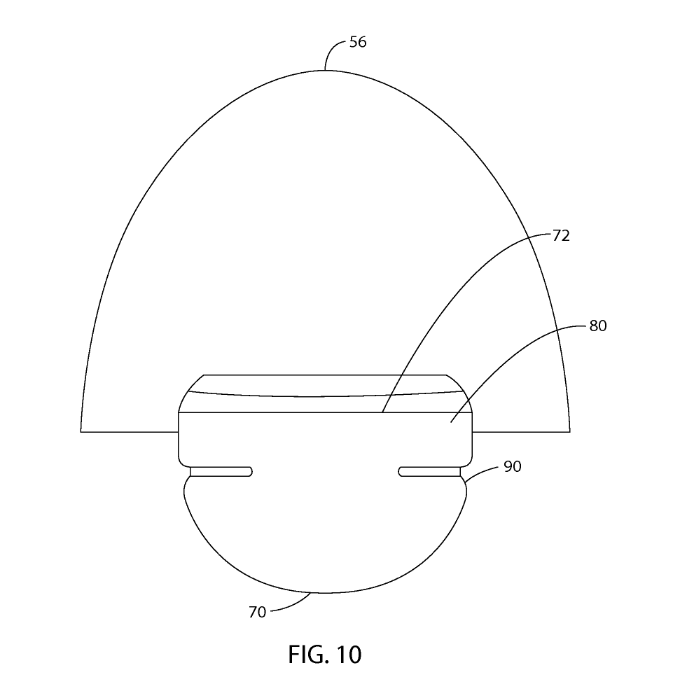

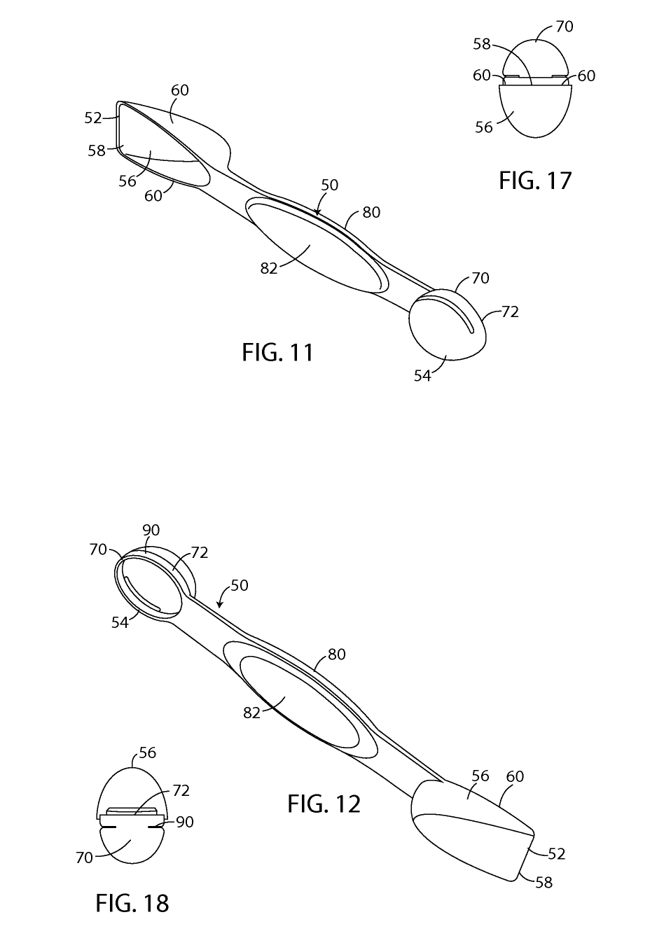

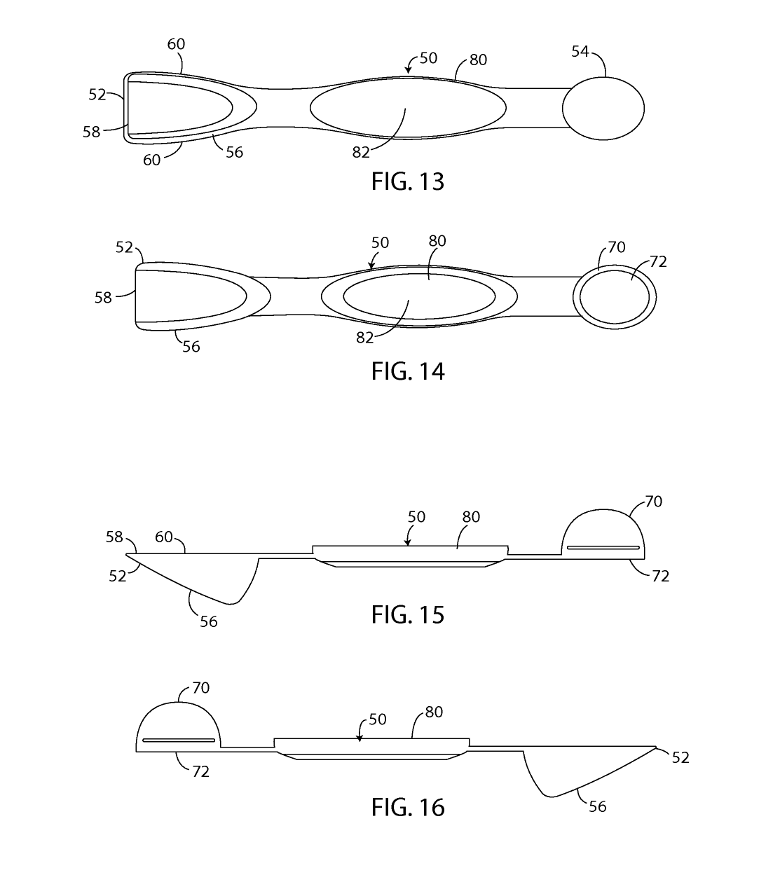

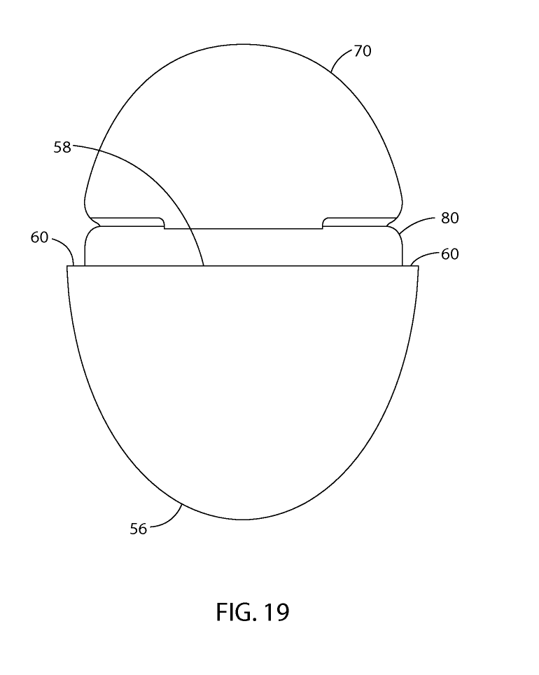

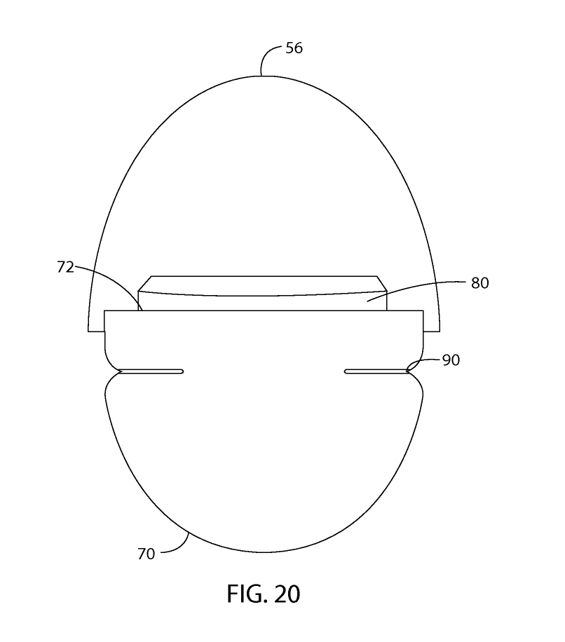

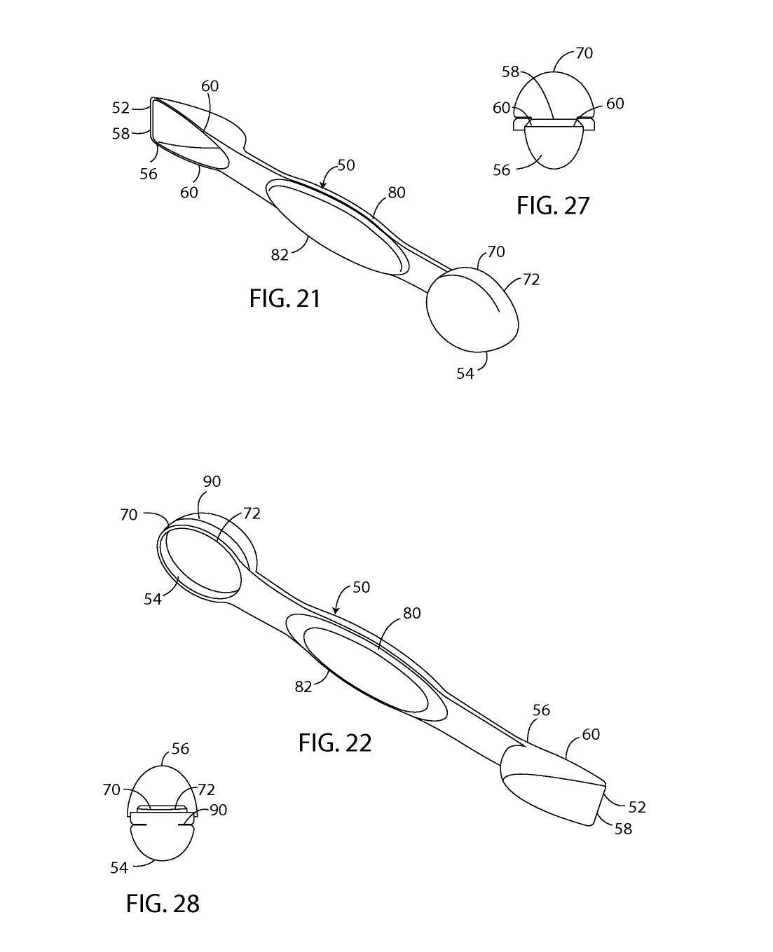

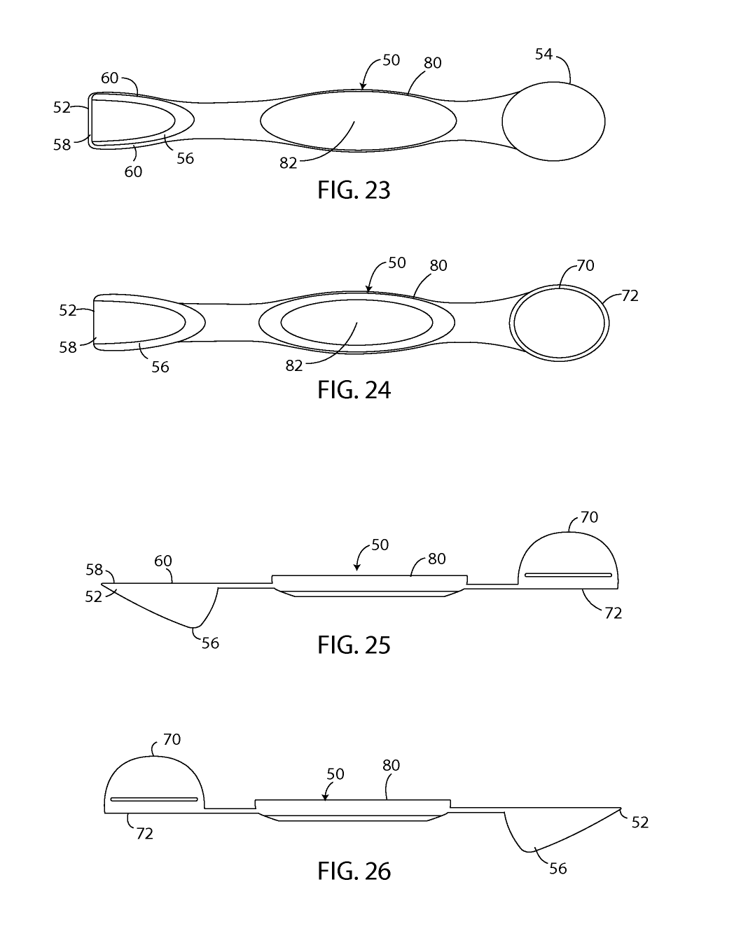

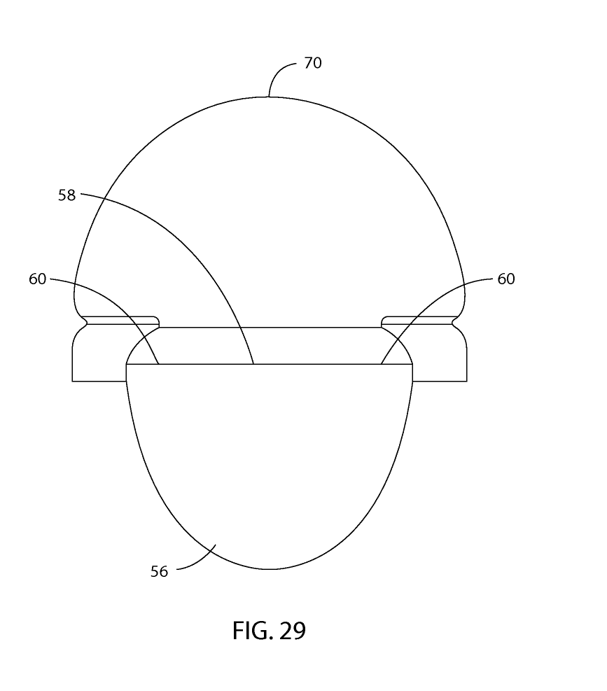

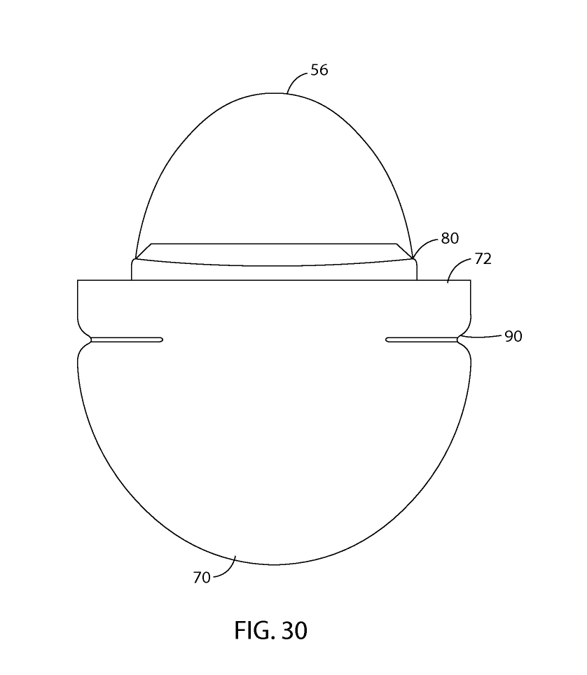

FIGS. 1-30 illustrate several embodiments of double-ended measuring spoons that generally prove useful in the kitchen for cooking and baking. The embodiments of FIGS. 1-30 comprise a set of three differently sized measuring spoons. A set of spoons may be any number, and the three embodiments shown in FIG. 1-30 is one example of a set. The features of each of the embodiments are generally the same except for their size, and accordingly, the features are indicated with the same reference characters. In each of the embodiments, the measuring spoon 50 has a first end 52 which is for dry measurements and an opposite second end 54 which is configured for liquid measurements. While the drawings show a measuring spoon with a first end for dry measurements and an opposite second end configured for liquid measurements, it is not necessary that the measuring spoon be double ended with one end for dry measurements and an opposite for liquid measurements. The measuring spoon may be double ended with both ends configured for dry measurements. The measuring spoon may be double ended with both ends configured for liquid measurements. The measuring spoon may have a single end with a handle. The single end may be configured for dry measurements or for liquid measurements. The spill reduction feature described below may be applied to any liquid measuring end, whether a single or double ended measuring spoon.

As shown in the drawings, the dry measurement end 52 may comprise a scoop member 56. The dry measurement end may have narrow and flat features that facilitate the insertion of the scoop member into spice containers and boxes that generally are used for packaging dry ingredients. A leading edge 58 of the dry measurement end scoop 56 member may be flat. The length edges 60 of the dry measurement end scoop member 56 may be generally angled to the leading edge 58. With reference to a plane parallel to the length edges 60 of the scoop member 56, the scoop member may have an interior with a generally triangular shape along such a plane. The side views of the drawing figures (e.g., FIGS. 5, 6, 7, 9, 15, 16, 17, 19, 25, 26, 27, 29) illustrate the triangular aspect of the scoop member 56. The narrow aspect or appearance of the scoop member 56 may be formed by arranging the length edges 60 of the scoop member to be at least about three times longer than the leading edge 58 of the scoop member. The angle between the leading edge 58 and the length edges 60, although acute, may be generally no less than about 70 degrees. The scoop member 56 may have a generally triangular outer rim defined by the length edges 60 and leading edge 58. The outer rim may define a generally triangular opening for the scoop member 56. Rounded corners and smooth transitions may be provided on scoop member 56 to soften its generally triangular shape.

The liquid measurement end 54 may be generally a cup-shaped member 70. The cup shaped member 70 may have an outer rim 72 defining the opening for the cup shaped member. The outer rim 72 may be oval or circular. The side views of the drawing figures (e.g., FIGS. 5, 6, 8, 10, 15, 16, 18, 20, 25, 26, 28, 309) illustrate the spherical aspect of the cup member 70. The interior of the cup shaped member may be curved. Although not shown in the drawings, the cup shaped member may have a flattened bottom.

The liquid measurement end cup-shaped member 70 and the dry measurement end scoop member 56 may be connected with a handle 80. The handle 80 may be arranged to extend from the outer rims (58,60 or 72) of the liquid measurement end cup shaped member and/or the dry measurement end scoop member. Top and bottom sides of the handle may be coterminous with the respective outer rims (58,60 or 72) of the liquid measurement end cup shaped member and/or the dry measurement end scoop member. The dry measurement end scoop member 56 may have its opening facing a direction that is opposite of the direction of facing of the opening of the liquid measurement end cup shaped member 70. The handle 80 and the liquid measurement end cup shaped member 70 and/or the dry measurement end scoop member 56 may be configured to allow spoons of various sizes to be nestable together. With the opposite orientation of the openings of the liquid measurement end cup shaped member 70 and the dry measurement end scoop member 56 as shown in the drawings, when multiple spoons are provided in a kit, the relative sizes of the liquid measurement end cup shaped member may be incremented while the relative sizes of the dry measurement end scoop member may be decremented, or vice versa. This may allow for the set of spoons to be relatively compact when nested together. The handle 80 may have magnet material disposed therein to allow multiple spoons to be retained as a set. The handles may be magnetically attracted to each other to hold a set of spoons together in the nestable configuration. The handles may be color-coded to indicate the capacities and volumes associated with the measuring sizes of the liquid and dry measurement ends. The handles may also have indicia 82 indicating the measuring sizes of the liquid and dry measurement ends.

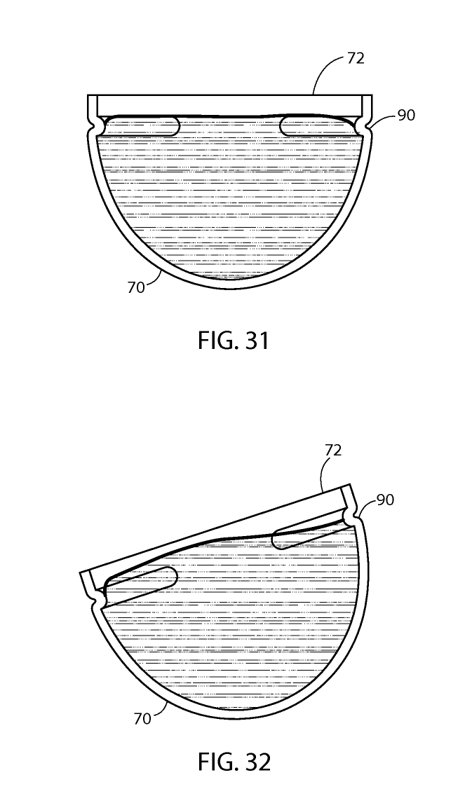

The liquid measuring end cup shaped member 70 may be provided with a spill reduction feature. The spill reduction feature may comprise a protrusion 90 formed on the interior surfaces of the cup shaped member 70. The protrusion 90 may be formed below the outer rim 72 the cup shaped member 70. The measuring capacity of the liquid measurement end may correspond to the position of the protrusion 90 in the interior of the cup shaped member. The protrusion 90 may circumscribe the entire interior surface of the cup shaped member. The protrusion 90 may have breaks along the interior surface of the cup shaped member. The protrusion 90 may be visible from the exterior of the cup shaped member. The protrusion 90 allows liquid disposed in the cup shaped member 70 to be maintained in the volume defined by the interior surfaces of the cup shaped member. The protrusion 90 holds the meniscus of liquid disposed in the volume of the cup shaped member downward and facilitates the user in handling liquids that are dispensed from the liquid measuring end cup shaped member. FIGS. 31-32 provide an illustration of the protrusion 90 in a liquid measurement end cup shaped member 70 and how the liquid meniscus behaves with respect to the protrusion. By forming the protrusion below the outer rim 72 of the measuring cup, the protrusion 90 is able to retain the meniscus downward and limit spillage that might otherwise occur from minor amounts of tilting of the measuring spoon.

In view of the foregoing, it will be seen that the several advantages are achieved and attained. The embodiments were chosen and described in order to best explain the principles and their practical application to thereby enable others skilled in the art to best utilize the various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A measuring spoon having a cup member extending from a handle, the cup member being configured for measurement of liquids, the cup member having a smooth interior surface bounded by an outer rim and a protrusion below the outer rim parallel to the outer rim, the outer rim defining an opening of the cup member, the protrusion being arranged in the interior surface of the cup at a position corresponding to a specified liquid volume measurement of the measuring spoon cup member.

2. The measuring spoon of claim 1 wherein the measuring spoon cup member protrusion extends substantially around interior surfaces of the cup member.

3. The measuring spoon of claim 1 wherein the specified volume of the measuring spoon cup member is shown on the handle.

4. The measuring spoon of claim 1 wherein the measuring spoon handle comprises magnetic material.

5. The measuring spoon of claim 1 wherein the measuring spoon handle has a scoop opposite the cup member.

6. The measuring spoon of claim 5 wherein the scoop is configured for measurement of dry ingredients.

7. The measuring spoon of claim 6 wherein the scoop has an opening that faces a first direction and the opening of the cup member faces a second direction that is opposite the first direction.

8. The measuring spoon of claim 6 wherein the scoop has a flat leading edge.

9. The measuring spoon of claim 8 wherein the scoop has length edges generally angled to the leading edge.

10. The measuring spoon of claim 9 wherein the scoop leading edge is at least three times shorter than the length edges.

11. A plurality of measuring spoons forming a set of spoons, each measuring spoon of the set having a cup member extending from a handle, each cup member being configured for measurement of liquids, the cup member having a smooth interior surface bounded by an outer rim and a protrusion below the outer rim parallel to the outer rim, the outer rim defining an opening of the cup member, the protrusion being arranged in the interior surface of the cup at a position corresponding to a specified liquid volume measurement of the measuring spoon cup member.

12. The set of measuring spoons of claim 11 wherein each measuring spoon cup member protrusion extends substantially around interior surfaces of the cup member.

13. The set of measuring spoons of claim 11 wherein the specified volume of each of the measuring spoon cup members is shown on the handle.

14. The set of measuring spoons of claim 11 wherein each measuring spoon handle comprises magnetic material.

15. The set of measuring spoons of claim 11 wherein each measuring spoon handle has a scoop opposite the cup member.

16. The set of measuring spoons of claim 15 wherein each measuring spoon scoop is configured for measurement of dry ingredients.

17. The set of measuring spoons of claim 16 wherein each measuring spoon scoop has an opening that faces a first direction and the opening of the cup member faces a second direction that is opposite the first direction.

18. The set of measuring spoons of claim 16 wherein each measuring spoon scoop has a flat leading edge.

19. The set of measuring spoons of claim 18 wherein each measuring spoon scoop has length edges generally angled to the leading edge.

20. The set measuring spoons of claim 19 wherein each measuring spoon scoop leading edge is at least three times shorter than the length edges.
